(19) United States
(12) Patent Application Publication
(10) Pub. No.: US 2005/0050930 A1
(43) Pub. Date: Mar. 10, 2005

(54) Door lock set and methods of assembling and disassembling the door lock set

(76) Inventors: Ju-Lin Yang, Chia-Yi County (TW); Chia-Min Sun, Chia-Yi City (TW)

Correspondence Address: LADAS & PARRY LLP, 224 SOUTH MICHIGAN AVENUE, SUITE 1200, CHICAGO, IL, 60604, US

(21) Appl. No.: 10/934,267

(22) Filed: Sep. 3, 2004

(30) Foreign Application Priority Data
Sep. 5, 2003 (TW) 092124689
May 10, 2004 (TW) 093121670

(51) Int. Cl. E05B 27/04

(52) U.S. Cl. 70/493

(57) ABSTRACT

A door lock set including a cylinder lock unit which has a lock shell and a plug is disclosed. The lock shell has an axially extending protrusion which projects outwardly and radially from an outer periphery of the lock shell and which has a plurality of pin holes that receive respective springs and tumbler pins. A cover is disposed over the protrusion to cover the pin holes and is biased outward by the springs. The cover is compressible against the springs to reduce the size of the lock shell so that the lock shell can be inserted easily into a rear shank of a knob of the door lock set for assembly. In a preferred embodiment, the cover has two opposite lateral sides extending over and engaging movably two opposite lateral faces of the protrusion. Methods for assembling and disassembling the door lock set are also disclosed.

### CROSS-REFERENCE TO RELATED APPLICATIONS

This application claims priority of Taiwanese Patent Application No. 92124689 filed on Sep. 5, 2003 and Taiwanese Patent Application No. 93121670 filed on May 10, 2004.

### BACKGROUND OF THE INVENTION

1. Field of the Invention

This invention relates to a door lock set, more particularly to a door lock set and methods of assembling and disassembling the door lock set.

2. Description of the Related Art

Referring to FIG. 1, a typical door lock set includes a conventional cylinder lock unit 2′ installed within a knob 1′ which incorporates a knob cover 3′ attached to a shank part 13′ of the knob 1′. Thus, the conventional knob 1′ is of two-piece construction. Furthermore, the conventional cylinder lock unit 2′ has an axially extending protrusion 24′ which is formed with a plurality of pin holes (not shown) thereinside. The shank part 13′ of the conventional knob 1′ is provided with an axial groove 15′ so that the cylinder lock unit 2′ is permitted to enter the knob 1′ by allowing the protrusion 24′ to pass through the axial groove 15′ and so that a front end 22′ of the cylinder lock unit 2′ can be fitted in a front hole 14′ of the knob 1′ The knob cover 3′ is sleeved onto the shank part 13′ of the knob 1′ to cover the axial groove 15′. The shank part 13′ of the knob 1′ is attached to a lock spindle 4′ which has an axial groove 41′, and a plate 43′ loaded with a wire spring 42′. The lock spindle 4′ is mounted within a door panel and projects outward through a tubular portion of a cap 5′. The shank part 13′ is retained on the lock spindle 4′ by the spring-loaded plate 43′ which is biased in a diametric direction to engage a slot 16′ formed in the shank part 13′ and a slot 31′ formed in the knob cover 3′. The spring-loaded plate 43′ is aligned with a hole 52′ of the cap 5′ and can be pressed through the hole 52′ by using a tool so as to detach the knob 1′ from the lock spindle 4′. Engaging the spring-loaded plate 43′ with both of the slot 16′ of the shank part 13′ and the slot 31′ of the knob cover 3′ adds complication to the procedure of assembling the conventional cylinder lock unit 2′ and the knob 1′. In order to simplify the manufacture of the door lock set, a one-piece knob which has no axial groove 15′ has been suggested in the prior art to eliminate the use of the knob cover 3′. However, it is inconvenient to assemble and disassemble the door lock set having the one-piece knob.

### SUMMARY OF INVENTION

An object of the present invention is to provide a cylinder lock unit which has a compressible cover to facilitate assembly or disassembly of the cylinder lock unit and a one-piece knob.

Another object of the present invention is to provide a door lock set which can be easily assembled or disassembled.

Still another object of the present invention is to provide a simple method of assembling and disassembling a door lock set.

According to one aspect of the present invention, a cylinder lock unit comprises a lock shell which includes an axial hole, a protrusion which projects outwardly and radially from an outer periphery of the lock shell and which extends axially, and a plurality of first pin holes extending radially in the protrusion. The protrusion includes an outer surface which is disposed away from the outer periphery of the lock shell. Each of the first pin holes has an inner end connected to the axial hole and an outer end opening at the outer surface of the protrusion. The protrusion further includes two opposite lateral faces which extend axially on two sides of the first pin holes and which project from the outer surface of the protrusion toward the outer periphery of the lock shell. The cylinder lock unit further comprises: a plug mounted within the axial hole and including an axially extending key hole and a plurality of second pin holes which are connected to the key holes and which can be communicated with the first pin holes; a plurality of first tumbler pins respectively received in the first pin holes; a plurality of springs respectively received in the first pin holes; a plurality of second tumbler pins respectively received in the second pin holes; and a cover mounted movably on the protrusion and covering the first pin holes. The cover is biased outwardly by the springs and is compressible against the springs.

According to another aspect of the present invention, a method is provided for disassembling a door lock set which includes a cylinder lock unit, a lock spindle, and a one-piece knob which receives the cylinder lock unit and which has a rear shank connected to the lock spindle. The cylinder lock unit has a plug inserted into a lock shell. The lock spindle includes a spring-loaded plate engaging the knob, and an axial groove. The lock shell has a protrusion, a plurality of pin holes extending into the protrusion, a plurality of springs respectively received in the pin holes, and a cover disposed over the protrusion to cover the pin holes and urged outward by the springs. The cover is compressible against the springs. The method comprises: inserting a key into a key hole of the plug; turning the key and rotating the plug by a predetermined angle; pressing the spring-loaded plate and disengaging the knob from the lock spindle after the key is turned; turning back the key and the plug to the original position thereof; removing the key from the plug; inserting a rod into the key hole and pushing the rod rearward to extend out of the shank together with the plug and the lock shell; and removing the rod from the key hole.

According to still another aspect of the present invention, a method is provided for assembling the door lock set. The method comprises: inserting a rod into a key hole of the plug disposed within the lock shell; compressing the cover against the springs; inserting the rod along with the plug, the lock shell and the compressed cover into the knob through the rear shank of the knob until the rod extends out of the knob through a front aperture of the knob and until a front end of the plug is fitted in the front aperture of the knob; placing the rear shank of the knob around the lock spindle with the axial groove of the lock spindle receiving the protrusion of the lock shell; removing the rod from the key hole and inserting a key into the key hole; turning the key and the plug by a predetermined angle so as to engage the spring-loaded plate with the rear shank of the knob; and turning back the key and the plug and removing the key from the plug.

### BRIEF DESCRIPTION OF THE DRAWINGS

Other features and advantages of the present invention will become apparent in the following detailed description of the preferred embodiments of the invention, with reference to the accompanying drawings, in which;

FIG. 1 is an exploded view of a conventional door lock set;

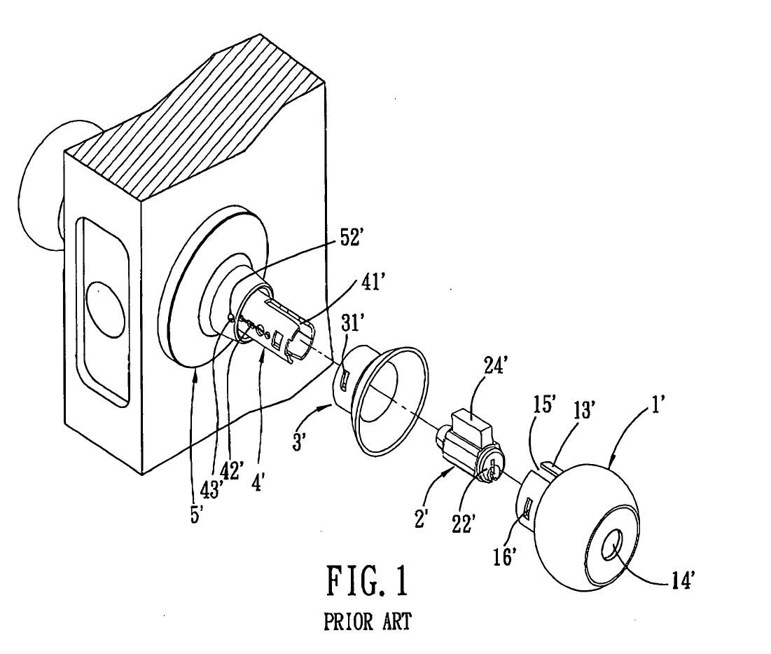

FIG. 2 is an exploded view of a cylinder lock unit used in the first preferred embodiment of the present invention;

FIG. 3 shows the first preferred embodiment of the door lock set according to the present invention mounted on a door panel;

FIG. 4 shows a key inserted into the door lock set of FIG. 3;

FIG. 5 shows that a knob containing the cylinder lock unit of FIG. 2 is removed from a lock spindle;

FIG. 6 shows a rod inserted into the cylinder lock unit;

FIG. 7 shows that the rod pushes the cylinder lock unit to be detached from the knob;

FIG. 8 shows the cylinder lock unit separated from the knob; and

FIG. 9 shows a cylinder lock unit used in a second preferred embodiment of the present invention.

### DETAILED DESCRIPTION OF THE PREFERRED EMBODIMENTS

Before the present invention is described in greater detail, it should be noted that same reference numerals have been used to denote like elements throughout the specification.

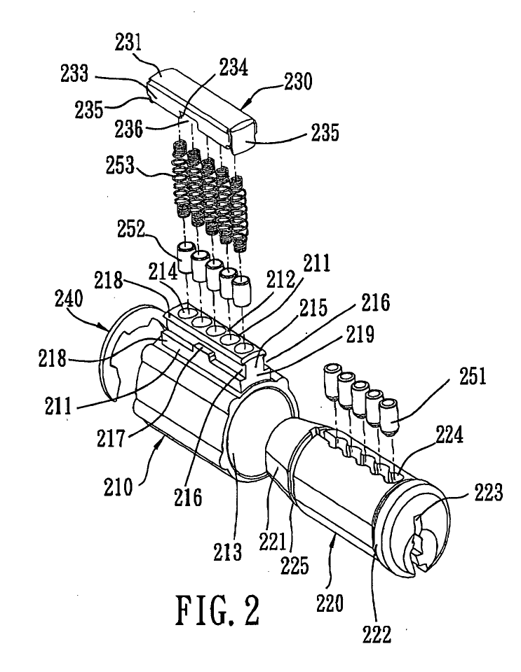

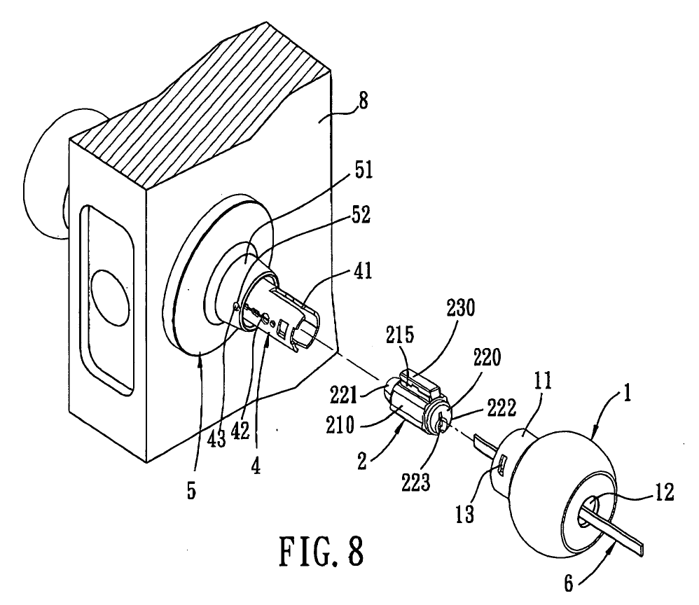

Referring to FIGS. 2 and 8, a first preferred embodiment of the door lock set according to the present invention is shown to include a one-piece knob 1 and a cylinder lock unit 2. The knob 1 is attached to a lock spindle 4 of a drive mechanism (not shown) of the door lock set, which is mounted within a door panel 8 for actuating a lock bolt (not shown). A cap 5 is mounted on an outer side of the door panel 8 to cover the drive mechanism. The lock spindle 4 projects outwardly through a tubular portion 51 of the cap 5 and is connected to the knob 1 to be rotated by the knob 1. The lock spindle 4 has an axial groove 41 and a plate 43 loaded with a wire spring 42. The spring-loaded plate 43 is biased in a diametrical direction and is aligned with a slot 52 formed in the tubular portion 51 so that the spring-loaded plate 43 can be depressed inward through the slot 52 of the cap 5 by using a tool.

The one-piece knob 1 includes a rear shank 11 and a front aperture 12. A hole 13 is formed in the wall of the rear shank 11. The rear shank 11 is inserted into the tubular portion 51 around the lock spindle 4 so that the lock spindle 4 extends into the knob 1. The spring-loaded plate 43 engages the hole 13 of the rear shank 11, thereby retaining the rear shank 11 within the tubular portion 51 and on the lock spindle 4.

The cylinder lock unit 2 includes a lock shell 210 disposed inside the knob 1 and the lock spindle 4. The lock shell 210 has an axial hole 213 receiving a plug 220. A protrusion 215 projects outwardly and radially from an outer periphery of the lock shell 210 and extends axially in the axial groove 41 of the lock spindle 4. The protrusion 215 has an outer surface 212 disposed away from the outer periphery of the lock shell 210 and two lateral faces 211 extending back to the outer periphery of the lock shell 210 from two opposed axial ends of the outer surface 212. A plurality of first pin holes 214 extend radially inside the protrusion 215. Each first pin hole 214 has an inner end connected to the axial hole 213 and an outer end opening at the outer surface 212 of the protrusion 215.

The plug 220 is mounted rotatably inside the axial hole 213 of the lock shell 210 and includes an axially extending key hole 223. A front end 222 of the plug 220 extends out of the lock shell 210 and is fitted in the front aperture 12 of the knob 1. A locking ring 240 is received in a peripheral groove 225 formed in a rear end portion 221 of the plug 220 which projects out from the axial hole 213. The engagement of the locking ring 240 with the peripheral groove 225 of the plug 220 prevents axial movement of the lock shell 210 relative to the plug 220.

A plurality of second pin holes 224 are formed in the plug 220 in communication with the key hole 223. As is known in the art, the second pin holes 224 are communicated with the first pin holes 214 when the plug 220 is in a normal position in which the plug 220 is not rotated by any key inserted into the key hole 223.

Each first pin hole 214 receives a first tumbler pin 252 and a spring 253. The spring 253 is adjacent to the outer end of the corresponding first pin hole 214. Each second pin hole 224 receives a second tumbler pin 251.

A cover 230 is mounted movably on the protrusion 215 of the lock shell 210 to cover the first pin holes 214. The cover 230 is biased outwardly by the springs 253 and is compressible against the springs 253. The corer 230 has a base plate 231 disposed over the outer surface 212 of the protrusion 215 and two lateral sides 233 respectively extending over the lateral faces 211 of the protrusion 215 from two opposed ends of the base plate 231.

Each lateral face 211 of the protrusion 215 has an axially extending recess 216 and two axially extending raised parts 218. The raised parts 218 are disposed on two sides of the recess 216 and define the recess 216. A protuberance 217 projects into the recess 216 from one of the raised parts 218 between two axially opposed ends of the recess 216 in each lateral face 211.

Each lateral side 233 of the cover 230 has a flanged end 234 that extends axially and inwardly to engage the recess 216 of one of the lateral faces 211 of the protrusion 215. A notched part 236 is formed in each lateral side 233 of the cover 230 corresponding in position to the protuberance 217 of the protrusion 215. No flanged end 234 is formed in each notched part 236. The flanged end 234 of each lateral side 233 interferes with the corresponding protuberance 217 so that the cover 230 is prevented from moving axially relative to the protrusion 215. The width of the recess 216 or the distance between the two raised parts 218 is larger than the width or thickness of the flanged end 234 so that the flanged end 234 is movable widthwise within the recess 216 and between the raised parts 218. Since no flanged end 234 is formed in each notched part 236, the widthwise movement of the flanged end 234 within the recess 216 is not affected by the protuberance 217. The base plate 231 of the cover 230 is movable away from or toward the outer surface 212 of the protrusion 215 by the action of the springs 253 or by an external force applied to the base plate 231. The cover 230 is therefore compressible.

The protrusion 215 of the lock shell 210 further includes two axially opposed front and rear end faces 219 (only the front end face 219 is shown) interconnecting the two lateral faces 211 of the protrusion 215. The cover 230 further includes two axially opposed front and rear tabs 235 respectively projecting from two axially opposed front and rear ends of the base plate 231 and extending over the front and rear end faces 219 of the protrusion 215.

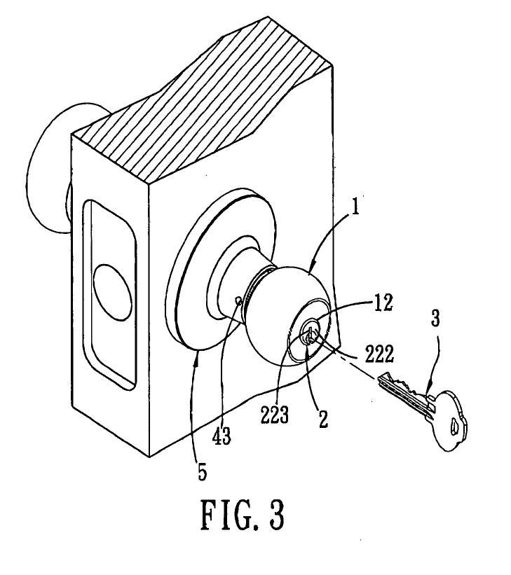

A preferred embodiment of the method of assembling and disassembling the door lock set according to the present invention will be described hereinafter with respect to FIGS. 3 to 8.

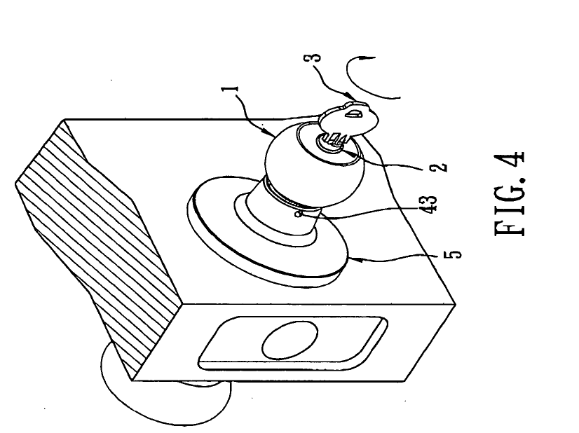

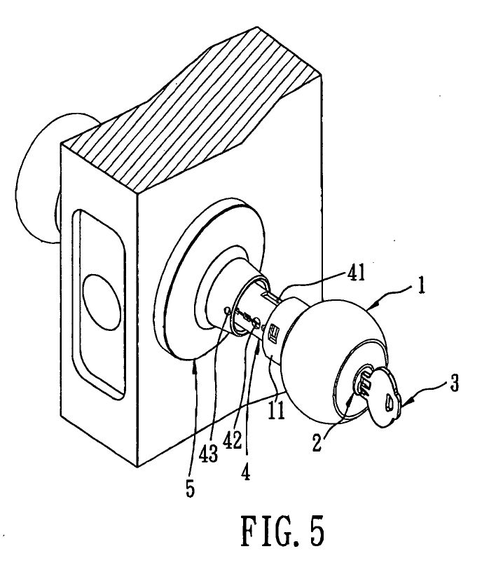

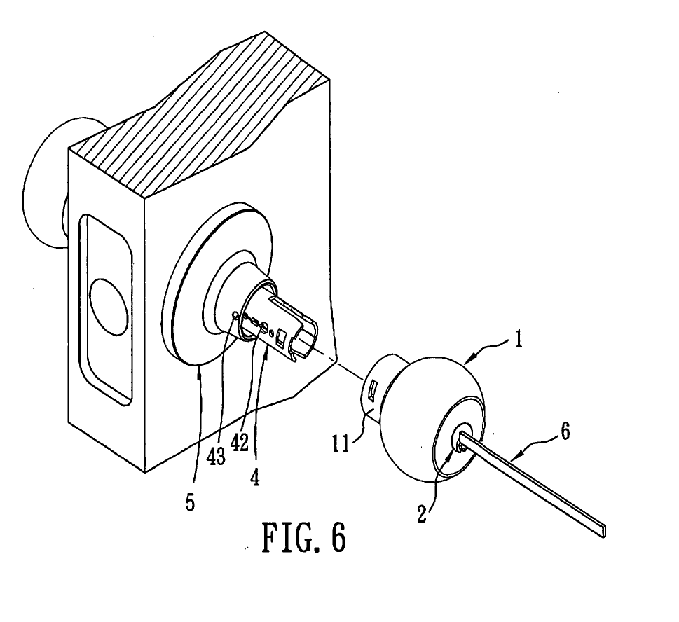

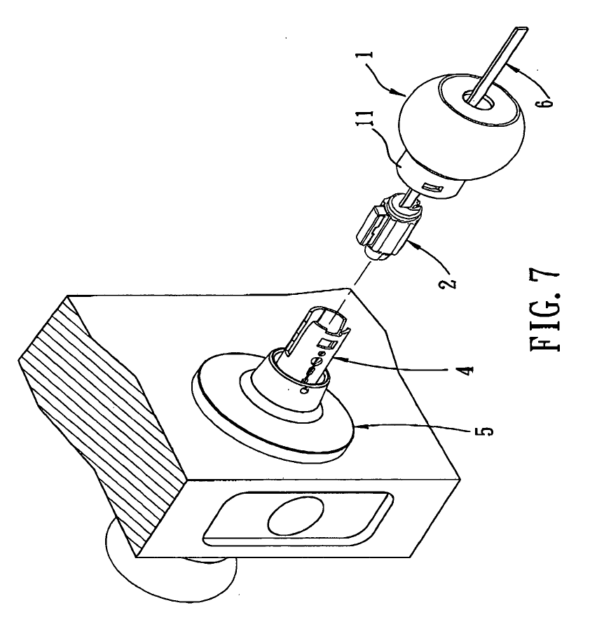

As shown in FIGS. 3 and 4, in order to disassemble the door lock set of the present invention, a key 3 is first inserted into the key hole 223 of the plug 220 and is turned to rotate the plug 220 by a predetermined angle, preferably, 90 degrees so that the lock shell 210 and the plug 220 are rotatable relative to each other. Then, the spring-loaded plate 43 is pressed to disengage the knob 1 from the lock spindle 4, and the key 3 is turned back together with the plug 220 to its original position, as shown in FIG. 5. After the key 3 is turned back, the key 3 is replaced by a rod 6, and the knob 1 is removed from the lock spindle 4, as shown in FIG. 6. When the rod 6 is pushed rearward, the cylinder lock unit 2 is removed from the rear shank 11, as shown in FIG. 7. Finally, the cylinder lock unit 2 is detached from the rod 6, and the rod 6 is removed from the key hole 223, as shown in FIG. 8.

The above-described procedure of disassembling the door lock set is substantially reversed in assembling the door lock set. The rod 6 is first inserted into the key hole 223 of the plug 220 and is further inserted into the knob 1 from the shank 11 of the knob 1, as shown in FIG. 7. Then, the cover 230 is compressed and the cylinder lock unit 2 is inserted into the knob 1 together with the rod 6 through the shank 11 until the rod 6 extends out of the knob 1 through the front aperture 12 and until the front end 222 of the plug 220 is fitted in the front aperture 12, as shown in FIG. 6. Afterwards, the rod 6 is replaced by the key 3, as shown in FIG. 5. The shank 11 of the knob 1 is sleeved around the lock spindle 4 with the axial groove 41 of the lock spindle 4 receiving the protrusion 215 of the lock shell 210. Thereafter, the key 3 is turned to rotate the plug 220 by a predetermined angle so that the spring-loaded plate 43 engages the shank 11 of the knob 1, as shown in FIG. 4. The key 3 is finally turned back and removed from the plug 220, as shown in FIG. 3.

As mentioned above, the door lock set according to the present invention can be assembled and disassembled easily for replacement of the cylinder lock unit 2. Due to the presence of the cover 230 which is compressible, the cross-sectional dimension of the lock shell 210 can be reduced so that the lock shell 210 is able to enter the shank 11 of the knob 1 and can be inserted easily into the knob 1 through the shank 11 during assembly. When the door lock set is disassembled, the lock shell 210 can also be removed easily from the shank 11 of the knob 1 as the cover 230 is placed in a compressed state within the shank 11.

The rod 6 used in the methods according to the present invention may be any rod which can be inserted into the key hole 223 of the plug 220. Preferably, the rod 6 has a length which is sufficient to push the plug 220 outward from the shank 11 of the knob 1 when the rod 6 is inserted into the key hole 223 and is pushed rearward. More preferably, the rod 6 has a length which is larger than an axial length of the knob 1. Furthermore, a right key of the plug 220 may be used as the rod 6 if it is provided with a sufficient length.

On the other hand, according to the present invention, a door lock set may be disassembled and re-assembled without using a right key of the plug thereof and without the need to turn the plug relative to a lock shell with the right key if the construction of the lock spindle and the cap thereof is so arranged that the slot of the cap is not aligned with the spring-loaded plate of the lock spindle 4. In an example, the door lock set is disassembled through the steps; inserting a rod into a key hole of the plug; aligning the spring-loaded plate with a hole in the cap by turning the lock spindle through a rotation of the knob; pressing the spring-loaded plate through the hole of the cap to disengage the knob from the lock spindle and detaching the knob from the lock spindle; pushing rearward the rod to extend out of the rear shank together with the plug and the lock shell; and removing the rod from the key hole.

In another example, a door lock set may be assembled through the steps: inserting a rod into a key hole of the plug; compressing the cover against the springs; inserting the rod along with the plug, the lock shell and the compressed cover into the knob through the rear shank of the knob until the rod extends out of the knob through a front aperture of the knob and until a front end of the plug is fitted in the front aperture of the knob; placing the rear shank of the knob around the lock spindle and engaging the spring-loaded plate with the knob.

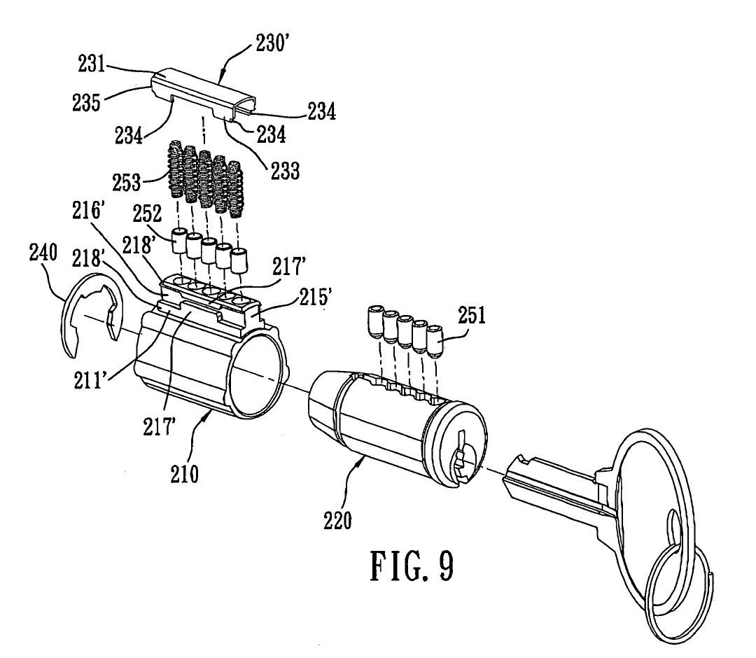

Referring to FIG. 9, a second preferred embodiment of the cylinder lock unit according to the present invention is shown to be similar to the first preferred embodiment except that the protrusion 215′ of the lock shell 210 has two protuberances 217, in each lateral face 211′ of the protrusion 215′ and that only one tab 235 projects from a rear end of the base plate 231 of the cover 230′. No tab 235 is provided at the front end of the base plate 231. The protuberances 217′ project respectively from two raised parts 218′ into the recess 216′. The cover 230′ in this embodiment can be assembled on the protrusion 215′ by sliding axially the cover 230′ over the protrusion 215′ from the rear end to the front end of the protrusion 215′ and by sliding the flanged end 234 through a gab between the two protuberances 217′.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A cylinder lock unit comprising:
a lock shell including an axial hole, a protrusion which projects outwardly and radially from an outer periphery of said lock shell and which extends axially, and a plurality of first pin holes extending radially in said protrusion, said protrusion including an outer surface which is disposed away from said outer periphery of said lock shell, each of said first pin holes having an inner end connected to said axial hole and an outer end opening at said outer surface of said protrusion, said protrusion further including two opposite lateral faces which extends axially on two sides of said first pin holes and which project from said outer surface toward said outer periphery of said lock shell;
a plug mounted within said axial hole and including an axially extending key hole and a plurality of second pin holes connected to said key hole, said second pin holes being able to communicate with said first pin holes;
a plurality of first tumbler pins respectively received in said first pin holes;
a plurality of springs respectively received in said first pin holes;
a plurality of second tumbler pins respectively received in said second pin holes; and
a cover mounted movably on said protrusion and covering said first pin holes, said cover being biased outwardly by said springs and being compressible against said springs.

2. The cylinder lock unit as claimed in claim 1, wherein said cover includes a base plate disposed over said outer surface of said protrusion, and two axially extending lateral sides that extend respectively over said lateral faces of said protrusion from two opposed ends of said base plate, said lateral sides of said cover respectively and movably engaging said lateral faces of said protrusion.

3. The cylinder lock unit as claimed in claim 2, wherein each of said lateral faces of said protrusion has an axially extending recess, each of said lateral sides of said cover having a flanged end that extends axially and inwardly to engage said recess of one of said lateral faces of said protrusion, said recess having a width larger than that of said flanged end so that said flanged end is movable widthwise in said recess.

4. The cylinder lock unit as claimed in claim 3, wherein each of said lateral faces of said protrusion further includes two axially extending raised parts which are formed on two sides of said recess and which define said recess, and a protuberance projecting from at least one of said raised parts into said recess between two axially opposed ends of said recess.

5. The cylinder lock unit as claimed in claim 4, wherein each of said lateral sides of said cover has a notched part corresponding in position to said protuberance.

6. The cylinder lock unit as claimed in claim 5, wherein said notched part of each of said lateral sides is free of said flanged end.

7. The cylinder lock unit as claimed in claim 4, wherein each of said lateral faces of said protrusion has a pair of said protuberances respectively projecting from said two raised parts into said recess.

8. The cylinder lock unit as claimed in claim 3, wherein said protrusion further has two axially opposed end faces interconnecting said lateral faces of said protrusion, said cover further including two axially opposed tabs respectively projecting from two axially opposed ends of said base plate and extending over said end faces of said protrusion.

9. The cylinder lock unit as claimed in claim 7, wherein said protrusion further has two axially opposed end faces interconnecting said lateral faces of said protrusion, said cover further including a tab projecting from one of two axially opposed ends of said base plate and extending over one of said end faces of said protrusion.

10. A door lock set for being mounted on a door panel, comprising:
a lock spindle adapted to be mounted rotatably on the door panel and having a spring-loaded plate and an axial groove;
a one-piece knob including a front aperture and a rear shank opposite to said front aperture, said rear shank of said knob being attached to said lock spindle through an engagement with said spring-loaded plate, said lock spindle extending into said knob;
a lock shell disposed inside said knob and said lock spindle, said lock shell including an axial hole, a protrusion which projects outwardly and radially from an outer periphery of said lock shell and which extends axially in said axial groove of said lock spindle, and a plurality of first pin holes extending radially in said protrusion, said protrusion including an outer surface which is disposed away from said outer periphery of said lock shell, each of said first pin holes having an inner end connected to said axial hole and an outer end opening at said outer surface of said protrusion, said protrusion further including two opposite lateral faces which extends axially on two sides of said first pin holes and which project from said outer surface toward said outer periphery of said lock shell;
a plug mounted within said axial hole and having a front end projecting outwardly from said lock shell and fitted into said front aperture of said knob, said plug including an axially extending key hole, and a plurality of second pin holes connected to said key hole, said second pin holes being able to communicate respectively with said first pin holes;
a plurality of first tumbler pins respectively received in said first pin holes;
a plurality of springs respectively received in said first pin holes;
a plurality of second tumbler pins received respectively in said second pin holes; and
a cover disposed movably over said protrusion and covering said first pin holes, said cover being biased outwardly by said springs and being compressible against said springs.

11. A method of disassembling a door lock set, the door lock set including a cylinder lock unit, a lock spindle, and a one-piece knob which receives the cylinder lock unit and which has a rear shank connected to the lock spindle, the cylinder lock unit having a plug inserted into a lock shell, the lock spindle including a spring-loaded plate engaging the knob, and an axial groove, the lock shell having a protrusion, a plurality of pin holes extending into the protrusion, a plurality of springs respectively received in the pin holes, and a cover disposed over the protrusion to cover the pin holes and urged outward by the springs, the cover being compressible against the springs, the method comprising:
(a) inserting a rod into a key hole of the plug;
(b) pushing the rod rearward so as to extend the rod outward from the rear shank together with the plug and the lock shell; and
(c) removing the rod from the key hole.

12. The method as claimed in claim 11, further comprising
(d) detaching the knob from the lock spindle before step (a), which includes:
(e) inserting a key into a key hole of the plug;
(f) turning the key and rotating the plug by a predetermined angle;
(g) pressing the spring-loaded plate and disengaging the knob from the lock spindle after the key is turned; and
(h) turning back the key and the plug to the original position thereof.

13. The method as claimed in claim 12, further includes the step of removing the key from the key hole before step (a) and after step (h).

14. The method as claimed in claim 11, further comprising (i) detaching the knob from the lock spindle between steps (a) and (b), wherein the rod is used in steps (a), (b) and (i).

15. A method of assembling a door lock set, the door lock set including a cylinder lock unit, a lock spindle, and a one-piece knob which receives the cylinder lock unit and which has a rear shank connected to the lock spindle, the cylinder lock unit having a plug inserted into a lock shell, the lock spindle including a spring-loaded plate engaging the knob, and an axial groove, the lock shell having a protrusion, a plurality of pin holes extending into the protrusion, a plurality of springs respectively received in the pin holes, and a cover disposed over the protrusion to cover the pin holes and urged outward by the springs, the cover being compressible against the springs, the method comprising:
inserting a rod into a key hole of the plug disposed within the lock shell;
compressing the cover of the lock shell against the springs;
inserting the rod together with the plug, the lock shell and the compressed cover, into the knob through the rear shank of the knob until the rod extends out of the knob through a front aperture of the knob and until a front end of the plug is fitted in the front aperture of the knob; and
attaching the knob to the lock spindle.

16. The method as claimed in claim 1S, wherein the step of attaching the knob to the lock spindle includes:
placing the rear shank of the knob around the lock spindle with the axial groove of the lock spindle receiving the protrusion of the lock shell;
removing the rod from the key hole and inserting a right key into the key hole;
turning the key and the plug by a predetermined angle;
engaging the spring-loaded plate with the rear shank of the knob; and
turning back the key and the plug and removing the key from the plug.
